(19) United States
(12) Patent Application Publication
(10) Pub. No.: US 2010/0065595 A1
(43) Pub. Date: Mar. 18, 2010

(54) Device for tying and transporting wood and elongate objects in relation to rearward portions of a forklift vehicle

(76) Inventor: Todd A. Brogden, Luttrell, TN (US)

Correspondence Address: MONROE ALEX BROWN, P. O. BOX 70501, KNOXVILLE, TN, 37938-0501, US

(21) Appl. No.: 12/584,400

(22) Filed: Sep. 4, 2009

Related U.S. Application Data
(63) Continuation-in-part of application No. 11/155,123, filed on Jun. 18, 2005, now abandoned.
(60) Provisional application No. 60/582,060, filed on Jun. 19, 2004.

(51) Int. Cl. B60R 9/06

(52) U.S. Cl. 224/401; 224/522; 224/534; 224/568

(57) ABSTRACT

A device for tying and transporting wood and elongate objects in improved positional relation to available aft or rearward portions of a forklift vehicle having a fuel tank, other structures or free surfacing available in such portions is disclosed. The device in one aspect of the invention is provided with at least one rack support member, and preferably two such rack support members, each for attachment to a vertical portion of a support column of the overhead guard of the vehicle. At least one of such rack support members is provided with a spool mounting bracket and axle subassembly for installment of a movable and rotating dispenser containing flexible and severable, tying or securing material.

### CROSS-REFERENCE TO RELATED APPLICATION

This application is a continuation-in-part of U.S. application Ser. No. 11/155,123, filed Jun. 18, 2005 and presently pending, which claimed priority for the benefit of Provisional Application filed for this invention on Jun. 19, 2004, filed under Ser. No. 60/582,060; each of which is incorporated herein by reference as if copied herein verbatim.

### BACKGROUND OF THE INVENTION

1. Field of the Invention

The present invention relates to an accessory device installed in positional relation to the vertical support columns of a fork lift's overhead guard area and the fuel tank and aft portions of a forklift, to be available to a rear portion of a fork lift vehicle to facilitate the additional storing and transporting of wood, sticks or other such lengthwise oriented items (other than fuel tank members); and to facilitate the ready availability of a spool carrying strap (strapping), rope, wiring, flexible/coilable elongate polymer tying materials, or other tying materials; for ready positional availability for tying or otherwise securing such wood, sticks or other lengthwise items stored in the device on the forklift.

2. Background Information

Over the years, it appears that very few references have addressed ideas at least in part relating to the enhancement of the ability of a conventional forklift vehicle to tie, carry and transport wood or elongate items in spatial portions or positioning between conventional vertical forklift protective support columns and conventional fuel tank placements or in aft or rearward portions of a forklift vehicle. References like Izumi et al., U.S. Pat. No. 4,846,499 address placement of the fuel tank itself rather than the special functional and structural abilities of the present invention to support elongate objects between or in relation to forklift vertical (or vertically oriented) support columns and an already positioned and installed fuel tank. Gedeon, U.S. Pat. No. 4,025,080 also addresses placement and support of a forklift fuel tank itself with no regard to the ability of this device to assist in supporting wood or elongate member positioning, tying and transport as described in the present invention. Muzzi et al., U.S. Pat. No. 5,662,451 discloses a “game hoist” installed on an ATV, designed to raise singular respective game carcasses vertically above the ground; and not reasonably adaptable for forklift-type vehicles or serving functionally to tying, carrying and transporting wood or elongate objects along width oriented portions between or in relation to aft forklift support columns and an already positioned and installed forklift fuel tank.

The prior art suffers from a number of draw-backs in their respective use and function. None of such prior art devices appear to address the ability of operating, functionally and structurally, in positional relation to the rearward columns of an overhead-guard of a fork lift vehicle for carrying wood, sticks or other such elongate members in a secure carrying position in a rearward width portion of the fork lift, away or separated from an installed fuel tank or a like member; and more specifically between or in relation to such forklift columns and installed fuel tank or aft portions themselves; nor does any of the prior art afford the ready and easily accessible ability to utilize a closely retained spooling member for wrapping, tying or bundling wood or other elongate members. These prior art references fail to disclose the ability to better organize and individualize for forklift transport such groups or plural elongate members such as wood, sticks, piping, rods, steel or iron members or other elongate or lengthwise oriented items, which a worker may desire to carry or transport in positional relation to the available spacing between the fuel tank or other aft areas and the support columns of the forklift's overhead guards, in addition to whatever may be carried in the front section of a forklift vehicle.

Accordingly, it will be appreciated that the present invention has a great utilitarian advantage over the prior art of being easily, but securely, installed on the described available spacing in the rear portion of the forklift and the columns of an overhead guard on many existing and conventional forklifts, so as to make available a carrying portion for storing and transporting wood and elongate items, to further make available, in close positional orientation, a spooling means containing tying materials for ready access for tying such elongate items; and for providing additional ballast, or counter-balance, to a forklift vehicle when it is carrying other items in front portions thereof. It is also an advantage over the prior art and an object of the invention to provide, in longer embodiments and higher vertical positioning on the forklift's vertical support columns, a device for tying and transporting elongate objects in such positioning in relation to the support columns which extends above and over a fuel tank and other aft or rearward areas on the forklift.

It is, therefore, an object of the present invention to provide an easily installed accessory device for a forklift vehicle having a set of rack members which are attached to, and take advantage of the additional support available by virtue of the positioning of most beams or similar support structures of the overhead guard or other covering or protective structures shielding the driver's section of a forklift vehicle.

It is a further an object of the invention to secure its rack members along the overhead guard of the forklift so that elongate members placed in the racks, once installed, will be spaced or distanced appropriately from a liquid propane tank or other fuel tank on rear or aft portions of a forklift, or other fuel means or members placed in such rear portions of this type of vehicle or over or in relation to aft or rear areas having no fuel tank or protruding or vertically raised structures.

It is yet a further object of the present invention to provide a means of dispensing spooled tying materials, attached to one of the inventions rack members for easy and convenient access in relation to the rear area of the forklift, and the rack members of the invention, for providing tying materials for tying, wrapping or otherwise securing bundles or plural wood or elongate members, or other materials, stored in the invention's rack members.

And, it is a further object of the present invention to provide further utility and use for such storing, tying and/or transporting of elongate objects, to forklift vehicles, as well as added ballast or counter-weight to a forklift vehicle.

It is also an object of the present invention to provide a rack member system with an attachment means which can be positioned low on vertical support columns of a forklift to provide functional use in storing and transporting objects in a width spacing which exists between the forklift's support columns and installed fuel tanks or other structures in many forklifts; and, by utilization of the inventions attachment means, which can be positioned higher on vertical support columns to provide such functional use in spacing which exists between the support columns and areas over the fuel tank or other aft structures of the forklift or spacing beyond aft perimeters of the forklift.

It will, therefore, be understood that substantial and distinguishable structural and functional advantages are realized in the present invention over the prior art teachings; and that the present invention's novel structure, design and positional arrangement; diverse utility; and broad functional applications serve as important bases of novelty and distinction in this regard.

### SUMMARY OF THE INVENTION

The foregoing and other objects of the invention can be achieved with the present invention, device and system which is a Device For Tying And Transporting Wood And Elongate Objects In Relation To Rearward Portions Of A Forklift Vehicle.

In preferred embodiments, a wood and elongate member transport rack system and tie spool mounting means device is provided for use in achieving a positional advantage in mounting and carrying elongate objects, in positional interaction with a fork lift-type vehicle having a wheeled or tracked-chassis base for movement in relation to the ground and supporting fore and aft sections above the ground, a driver area in the fore section, and a protective roof or other member covering the driver area supported by at least first and second support columns generally vertical in positional orientation in relation to a generally flat ground area or at an angle slightly off-vertical in placement. The aft section inherently defines imaginary positional coordinates where the width thereof is defined generally along the x-axis, the length thereof generally defined along the y-axis and the vertical magnitude thereof, above and below itself in relation to the ground or area which it occupies, defined generally along the z-axis. The vertical positioning of the first and second support columns of the protective roof is generally parallel with the z-axis. The aft section conventionally has and supports a fuel tank, or vertically raised or protruding structure, generally positioned along the x-axis in spaced relation to the first and second vertically oriented support columns.

In related preferred embodiments the device of the present invention comprises a first support rack member having first and second sections attached to one another. The first section has means for vertically positionally or attaching the free end thereof to a vertical portion of the first support column such that, as installably positioned, the first section extends generally parallel to the y-axis of the aft section. The second section is attached to the first section at a generally transverse angle, extending above the first section and the aft section generally parallel to the z-axis. The device also has a second support rack member having first and second sections attached to one another. The first section has means for vertically attaching the free end thereof to a vertical portion of the second support column such that, as installably positioned, the first section extends generally parallel to the y-axis of the aft section. The second section is attached to the first section at a generally transverse angle, extending above the first section and the aft section generally parallel to the z-axis. The first section of the second support rack member is positioned generally along the x-axis spaced and separate from the first section of the first support rack member, and generally parallel to the y-axis, so that elongate objects generally positioned along the x-axis and intersecting therewith can be supported by the first and second support rack members, when in installed position, between the fuel tank of the aft section and the first and second columns; and so that such elongate objects, when so dimensioned, when positioned onto the first and second support rack members, can extend beyond the width of the aft section and the perimeters of the first and second support columns.

In this related regard, the device further comprises a tie spool mounting subassembly having at least first and supportable ends. The first end is fixedly attached to the second section of the first support member so that the supportable end extends generally parallel to the y-axis. The supportable end has a securable elongate axle member extending generally parallel to the x-axis and a support member attached at a generally transverse angle to the supportable end such that it extends to a position generally flush with the aft section and generally parallel to the z-axis.

Also in this regard the device further has a tie material spool dispenser. The dispenser is rotateably and pivotably mounted on the elongate axle member, and has exchangeable means for securing the tie material spool dispenser as mounted on the elongate axle member. The means for vertically attaching the free end of the first support member comprises a base plate having at least two holes, and is provided with at least one securing U-bolt member for engagement and registering with these two holes for securing the base plate to a portion, preferably a vertical portion, of the first support column of the vehicle. The means for vertically attaching the free end of the second support member comprises a base plate defining at least two holes, and at least one securing U-bolt member for engagement and registering with these two holes for securing the base plate to the portion of the second support column. The tie spool mounting means further has a support member attached to a portion of the supportable end of the tie spool mounting means, and at least a portion thereof extends generally along the z-axis to make contact with and provide support from the aft section of the vehicle.

In preferred embodiments the invention is provided as a device having at least one rack member, preferably L-shaped in configuration; but which can have first and second members forming different shapes and angles in relation to each other. In preferred embodiments of the invention two such L-members are provided for installation, in interaction or in combination with the vertical-oriented support columns of the overhead guard and/or other protective or vertically oriented areas of a forklift vehicle proximal or proximate to aft areas of the vehicle.

In another aspect of the invention at least one of the rack members, of preferably two (2) such rack members utilized in preferred installed embodiments, is provided with a support member for movably, rotationally and/or pivotably supporting a spool or other dispenser of tying or securing material for use in binding, wrapping or otherwise securing items to be transported, stored or gathered or with regard to similar or other activities. The support member is attached one or more respective rack members. The rack member is securely but inter-positionally and releasably and movably attached at a preselected vertically oriented position on an overhead guard portion of a forklift vehicle, preferably existing support columns of protective forklift structures or at other available or affording vertical positioning locations, portions or positions of a forklift vehicle, so that a spool or other tie-dispenser can be positionally available to the rack member utilized to carry or transport items by the forklift, including elongate members or other transport materials. As indicated, each respective rack member can be moved and secured to different positions on a vertically oriented support column or other available positioning on an overhead or protective guard or roof portion of a forklift vehicle, or in relation to supporting members on a forklift for supporting an overhead guard structure on such a vehicle. In this regard, the present invention can be adapted or retro-fitted, integrally or by virtue of attached parts, to a diverse multitude of forklift vehicles including, without limitation, propane tank, diesel, electric, gas, or other driven, fueled, energized or activated forklift vehicles, or similar vehicles.

In other aspects of the transport rack system of the present invention both the rack member and the spool support member are provided as L-shaped or other shaped or positionally structured members attached to one another. The spool axle or dispenser mounting member of the present rack system is preferably mounted on the L-shaped support member so as to form an imaginary z-axis in relation to two arms or members of the support member forming by virtue of their own positional relationship an imaginary Cartesian x and y axis, and such similar axes formed in relation to aft portions of a forklift vehicle and the support or ground area upon which the vehicle is placed.

In other aspects of the invention the rack member is secured, as indicated by example, in relation to forklift overhead guard portions by a U-bolt, or other such coupling or securing means so that the rack member is secured to the overhead guard or preferably vertically oriented support columns thereof without the need of drilling holes or otherwise fluting or disturbing the internal structural integrity of such structures or members. In such aspects of the invention the U-bolt secures a base member or plate, or flanged base member or plate, on each rack member to the forklift overhead guard, columns thereof or the related structures described.

When so utilized, the spool or dispenser support member can be integrally, severally or separately attached to the rack member through many means of attachment and/or integral structuring.

In other aspects of the invention the spool or dispenser support member is provided with a spool or other dispenser housing, making available various types of tying or securing materials, items or substances mounted or dispensably installed on the invention's spool. The spool axle or dispenser mounting member is provided with hand-turnable nut, clip, coupling or other securing means, when necessary, for more securely holding a spool or dispenser in installed pivotal, rotating, movable or non-movable position, as the user may require in utilizing tying materials installed on the spool for securing or compartmentalizing wood or elongate objects.

In aspects of the invention the rack system is mounted separately onto a forklift vehicle, to function in interaction with such a vehicle; or in other mounted embodiments of the invention in combination with a forklift vehicle. In other aspects of the invention the rack system is mounted by connected or attached parts/members, or integrally mounted, on a forklift vehicle, preferably on support columns of an overhead guard portion thereof, for use in combination with such a vehicle, or on a forklift vehicle having rear or cabin portions thereof making at least some vertical positioning available for installation and mounting of the present invention. The rack system can also be utilized on any type of overhead guard structure in any type of vehicle or any type of vehicle which makes vertical attachment possible; but is preferably designed for and used on forklift, transporting and storage vehicles having the available vertical attachment locations for ideal attachment, support and positioning of the present invention.

In another aspect of the invention the spool or dispenser support member is mounted respectively and separate of the rack member along a wall or other proximal or near-by surfacing of a cabin or driver's area of a forklift or other vehicle.

### BRIEF DESCRIPTION OF THE DRAWINGS

FIG. 1 is a perspective view illustrating the novel Wood And Elongate Member Transport Rack System And Tie Spool Mounting Bracket of the present invention, installed on an exemplar type of Forklift vehicle, with which it interacts, and illustrating an installed spool member, with which the invention also interacts.

FIG. 2 is an elevated perspective view of the present invention illustrating an installed spool member in broken lines, and a wing nut and securing member. The invention is illustrated in partial portion attached to two respective portions of an exemplar (or example-type of) overhead guard of a forklift vehicle.

FIG. 3 is an elevated perspective of the present invention, illustrating a preferred embodiment of the invention, where the spool support member of the invention is installed on the opposite side of a forklift vehicle in relation to the installation shown in FIG. 2; and illustrating the washer as a part of the invention, and the spool member as a part with which the present invention is designed to interact, in preferred embodiments thereof.

FIG. 4 is a side view of one of the rack members of the present invention, in a preferred embodiment of the invention.

FIG. 5 is a side view of one of the rack members of the present invention, illustrating the attached spool support member of the invention, and an exemplar spool component or unit utilized in relation to this member, and with which the invention interacts.

FIG. 6A a perspective view of the spool support member of the present invention, illustrating the utilization of the washer and exemplar securing members of the invention.

FIG. 6B is a front and right side perspective view of another preferred embodiment of the present invention, illustrating, by example, connection to one of the support columns of an overhead guard of a forklift.

FIG. 6C is a rear elevated view of the embodiment of FIG. 6B of the present invention illustrated in FIG. 6B.

FIG. 6D is a perspective view of the embodiment of FIG. 6B, illustrating, by example, the connection of the present invention to the overhead guard portion of an exemplar forklift vehicle (shown in broken-lines)

FIG. 6E is a perspective view of the embodiment of FIG. 6B illustrating connection to a forklift overhead guard, the connection of a rotatable spool, and spool wingnut securing means in broken-lines.

FIG. 6F is a sketched drawing of the spool support, and connection means, of the present invention, setting forth a perspective view illustrating, by example only, dimensioning which can be utilized as a part of one embodiment of the invention for the elements of the invention illustrated therein.

FIG. 7 is an enlarged elevated perspective view of the present invention set forth generally in an opposite positional view to that of FIG. 1, showing a portion thereof attached in relation to the overhead guard of an exemplar forklift vehicle with which the present invention interacts.

FIG. 8 is an enlarged partial perspective view of an embodiment of the vertical attachment means of the present invention.

FIG. 9 is a partially enlarged perspective showing a flanged vertical attachment means of the invention and other aspects of the rack support members of the invention.

FIG. 10 is a left elevational view of the embodiment of FIG. 6B.

FIG. 11 is a front elevational view of the embodiment of FIG. 6B.

FIG. 12 is a right elevational view of the embodiment of FIG. 6B.

FIG. 13 is a top elevational view of the embodiment of FIG. 6B.

FIG. 14 is a bottom elevational view of the embodiment of FIG. 6B.

FIG. 15 is an example of a conventional forklift vehicle (in broken lines) showing the axis alignment of aft portions of the vehicle.

FIG. 16 is a partial perspective of forklift roof support columns and aft portions showing the present invention installed in a second elevated vertical position.

FIG. 17 is a perspective of part of a conventional forklift vehicle (in broken lines) showing an embodiment of the present invention installed in a another vertical position on a vertical support column of the vehicle.

FIG. 18 is a perspective view of another embodiment of the present invention.

FIG. 19 is a perspective view of another embodiment of the invention related to that of FIG. 18.

FIG. 20 is an enlarged partial perspective of another embodiment of the invention.

FIG. 21 is an enlarged partial perspective of the embodiment of FIG. 3 of the invention.

FIG. 22 is a perspective of another embodiment of the invention showing a longer configuration of the present invention extending out over aft areas of a forklift-type vehicle.

### REFERENCE NUMBERS

10 Present Invention, Wood And Elongate Member Transport Rack System And Tie Spool Mounting Bracket, or “Rack System”
11 Forklift Vehicle (Exemplar)
11A wheeled or tracked-chassis base of the forklift vehicle (11)
11B driver area of (11)
11G ground area upon which the vehicle (11) is placed or situated
11R Aft Section(s) or Rearward Portions of (11)
11 LP Exemplar Example Of A Conventional Liquid Propane Tank
12 first rack member or first support rack member
12A first section of (12)
12B second section of (12)
11W Wood or Elongate Member Transport Load
14 surface beam portion
15A first end of (14)
15B second end of (14)
16 side beam portion of (12)
17A first end of (16)
17B second end of (16)
18 base plate of (14)
19 bolting holes of (18)
20 first U-Bolt of (18)
22 second U-Bolt of (18)
21 first U-Bolt Nuts of (20)
23 second U-Bolt Nuts of (22)
25 overhead guard structure of (11)
24 installment holes of side beam portion (16)
24A installment bolt for (24)
24B installment bolt for (24)
25A first selected position on overhead guard (25)
26 spool support bracket member
27A first support column of (25)
27B second support column of (25)
28 connection shaft (or portion) of (26)
28A first end of (28)
28B second end of (28)
29 attachment holes of (28)
30 support shaft (portion) of (26)
30A first end of (30)
30B second end of (30)
31 spool member
31T Tying Material
32 axle member
33A base diameter of (32)
33B central axle diameter of (32)
33C threaded portion of (32)
34 washer member
35 axle securing member (means) (wingnut, clip, etc.)
36 second rack member
36A first section of (36)
36B second section of (36)
38 surface beam portion of (36)
39A first end of (38)
39B second end of (38)
40 side beam portion of (36)
41A first end of (40)
41B second end of (40)
42 base plate of (38)
42A flanged base plate
43 bolting holes of (42)
44 first U-Bolt of (42)
46 second U-Bolt of (42)
45 first U-Bolt Nuts of (44)
47 second U-Bolt Nuts of (46)
25B second selected position on overhead guard (25)
50A backup support member
50B further backup support member
52 biasing member

### DETAILED DESCRIPTION OF THE PREFERRED EMBODIMENTS OF THE INVENTION

The following description of the preferred embodiments of the present invention is made in reference to the accompanying drawing figures which constitute preselected illustrated examples of the elements and functions of the present invention, among many other examples existing within the scope and spirit of the present invention.

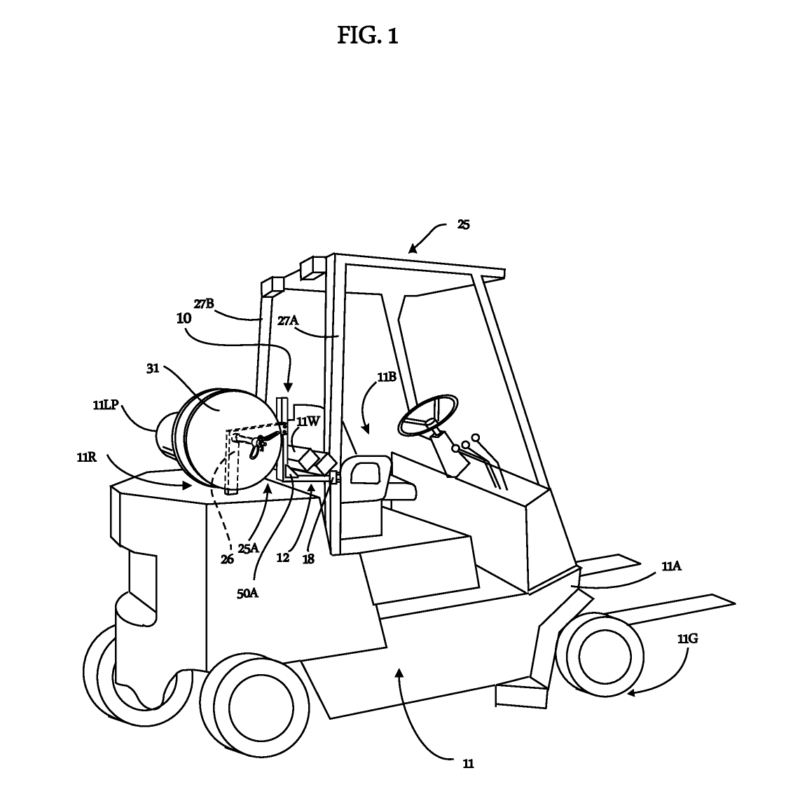

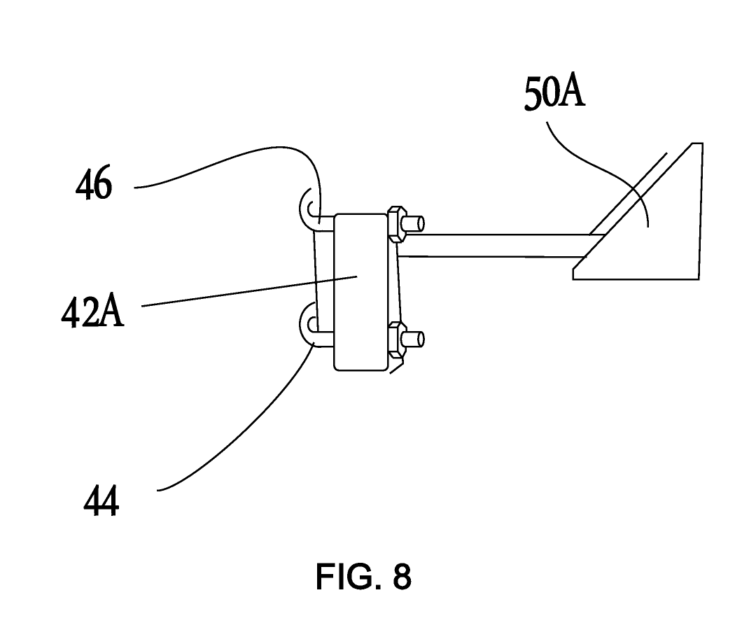

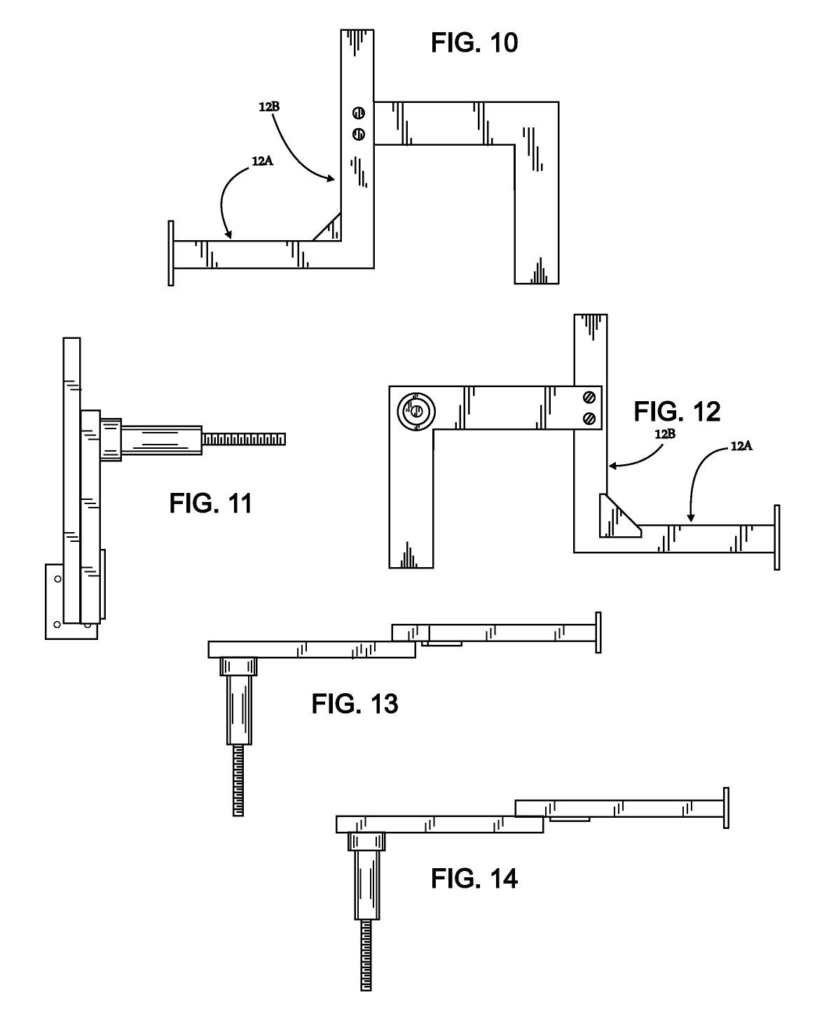

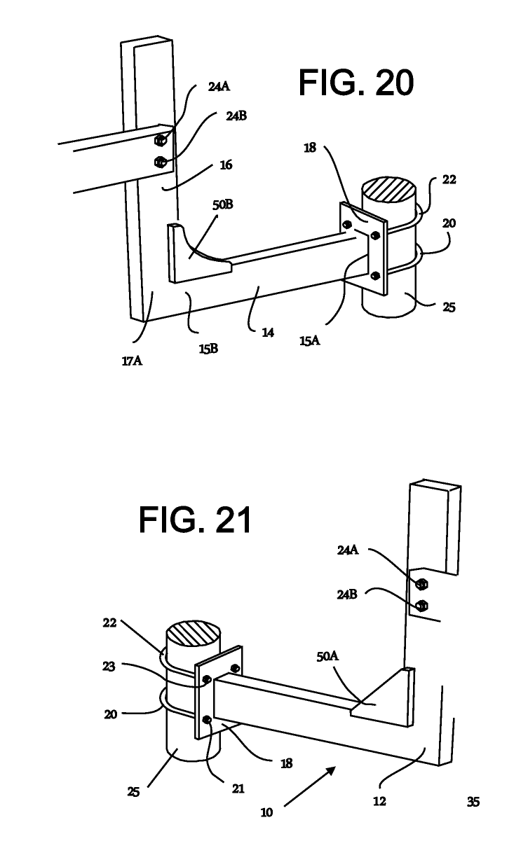

Referring now to the drawings and FIGS. 1 through 22, respectively; there is shown a Wood And Elongate Member Transport Rack System And Tie Spool Mounting Bracket, 10, also referred to herein as the Rack System, Invention or Present Invention 10.

The Rack System 10 is provided in a preferred embodiment with the first rack member 12. The rack member 12 has a surface beam portion 14 having first and second ends, respectively 15A and 15B. The first rack member 12 also has the side beam portion 16, having its first and second ends, 17A and 17B, respectively. The first end 17A of the side beam 16 is connected or attached (either in parts or integrally) to the second end 15B of the surface beam portion 14.

The first end 15A of the surface beam portion 14 is provided with a base plate 18; as illustrated by examples in FIGS. 1-3, 6B, and 6C; along with elements described above of the first rack member 12. These examples illustrate the base plate 18 as being both flat and curved to wrap around, at least in part, a beam of an overhead guard 25 of a forklift vehicle 11 with which it interacts, and in other embodiments as a flanged base plate which sets up against a respective support column of a forklift and wraps around at least part of the support columns and a portion of the U-bolts or other members used to secure the base plate to the support column. It will be appreciated that the base plate 18 may be utilized in a number of different configurations or shapes for the purpose of best utilizing, and taking advantage of, the overhead guard 25-surfacing available, for secure, but movably and re-positionable, connection with such an a vertical oriented support column of an overhead guard for a forklift type vehicle.

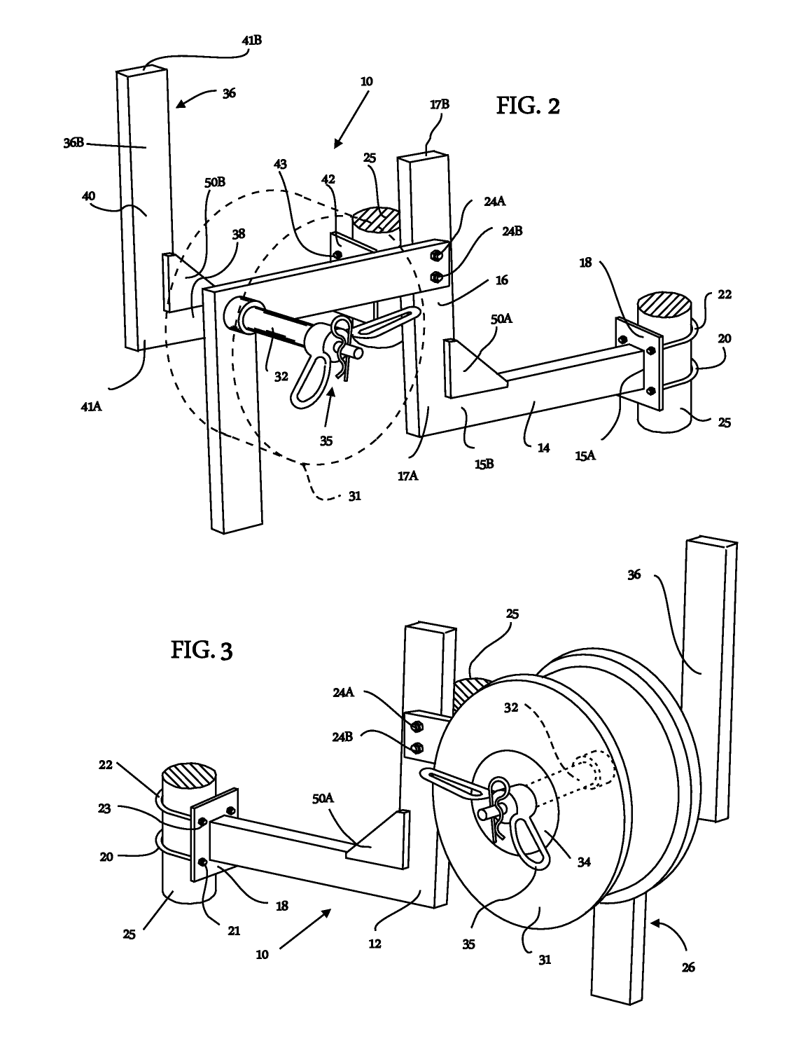

The base plate 18 is provided with a number; usually about 2 (two) to six (6), but preferably 4 (four) bolting holes 19, for securing the base plate 18; and, therefore, the first rack member 12 to which it is connected, to a first selected position 25A, on one section of the overhead guard 25A of the guard 25 of a forklift vehicle 11; as illustrated by example in FIGS. 2, 3, 6C, and 11 and other illustrations, by example, herein. The base plate 18 can best be positioned for connection to the overhead guard 25 in a number of preselected positions, which is discussed later in more detail, herein.

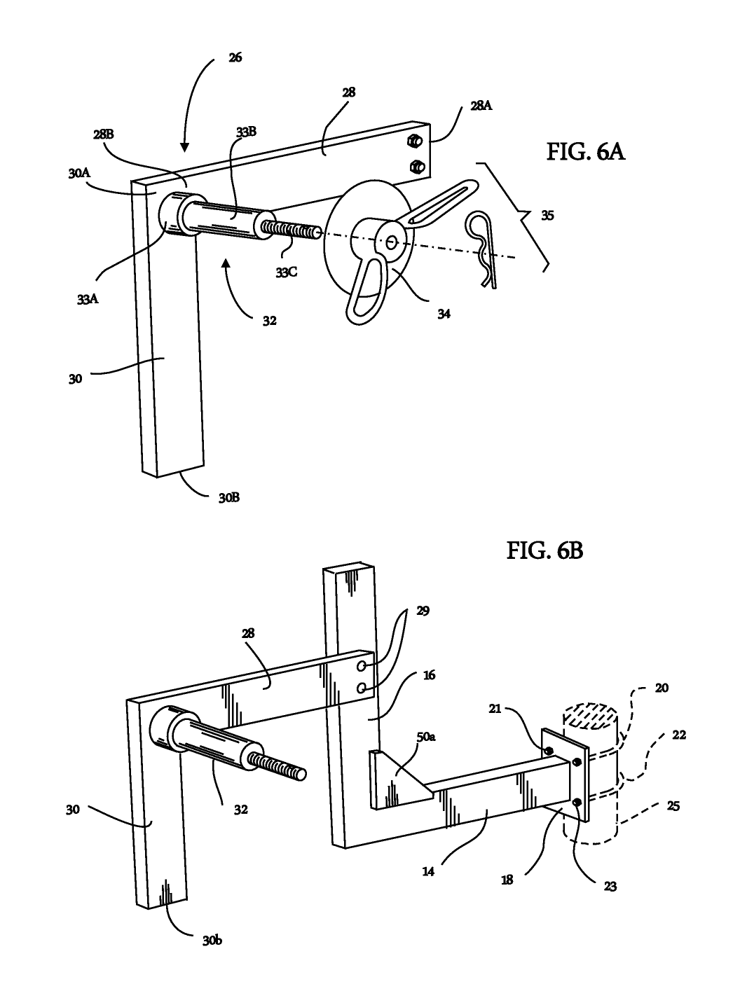

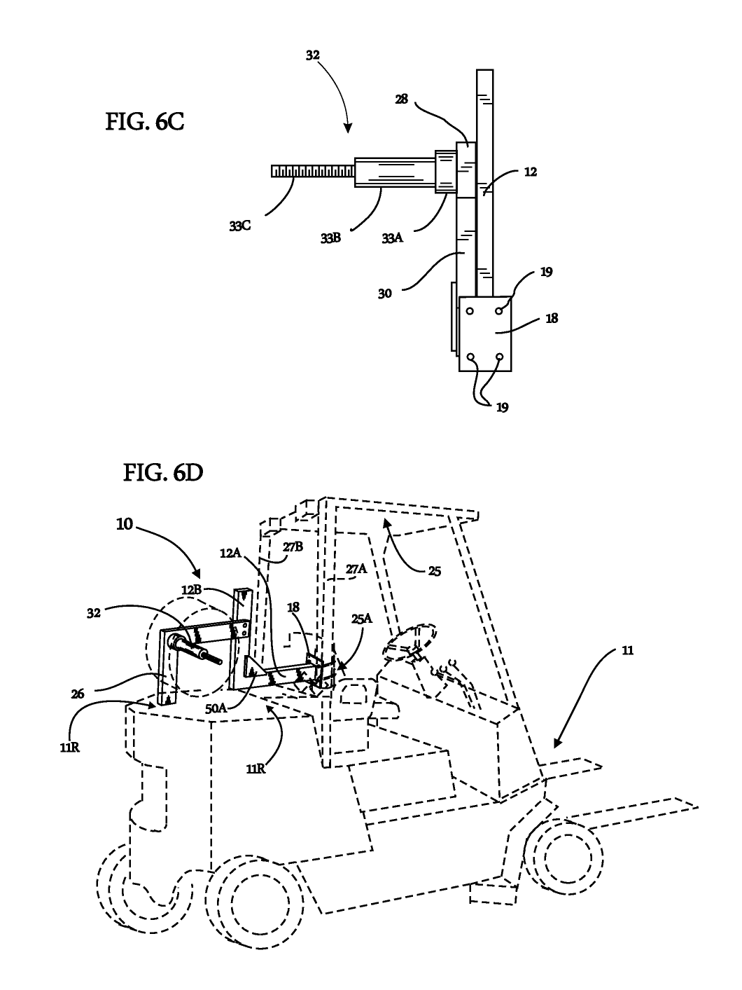

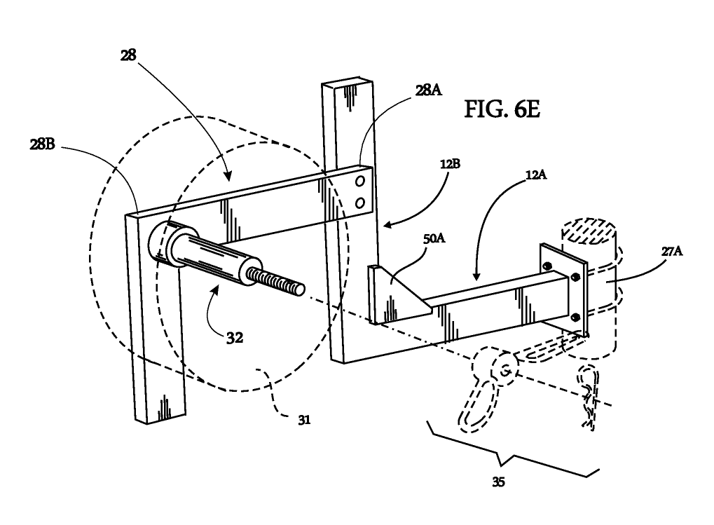

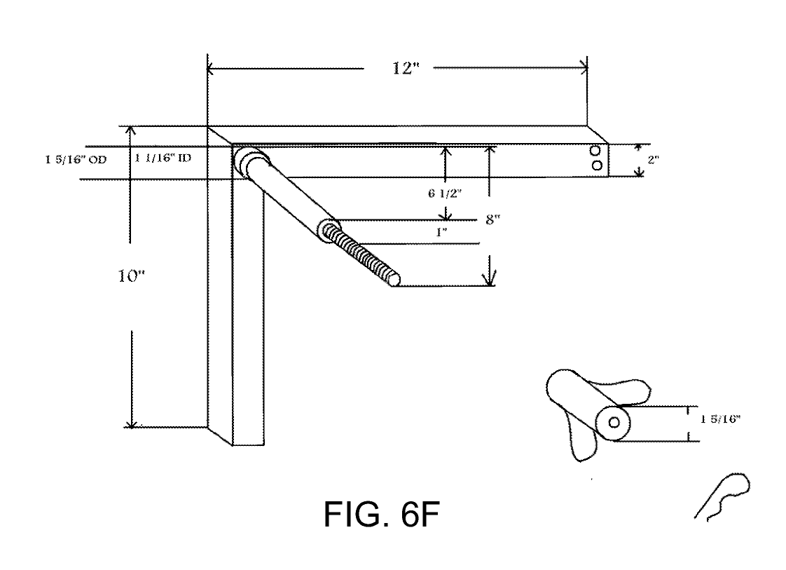

In a preferred embodiment of the present invention the base plate 18 is secured to the overhead guard 25 by utilizing a first U-Bolt 20 and a second U-Bolt 22, passed through the bolting holes 19 and secured, respectively, by first U-Bolt Nuts 21 and second U-Bolt Nuts 23; as illustrated by example in FIG. 6B, and other illustrations herein. Each of the U-Bolts 20 and 22 can be square or rectangularly shaped or configured to best provide positive securing function to the given, or existing available, shape of the overhead guard 25 which may be encountered in a given forklift vehicle 11.

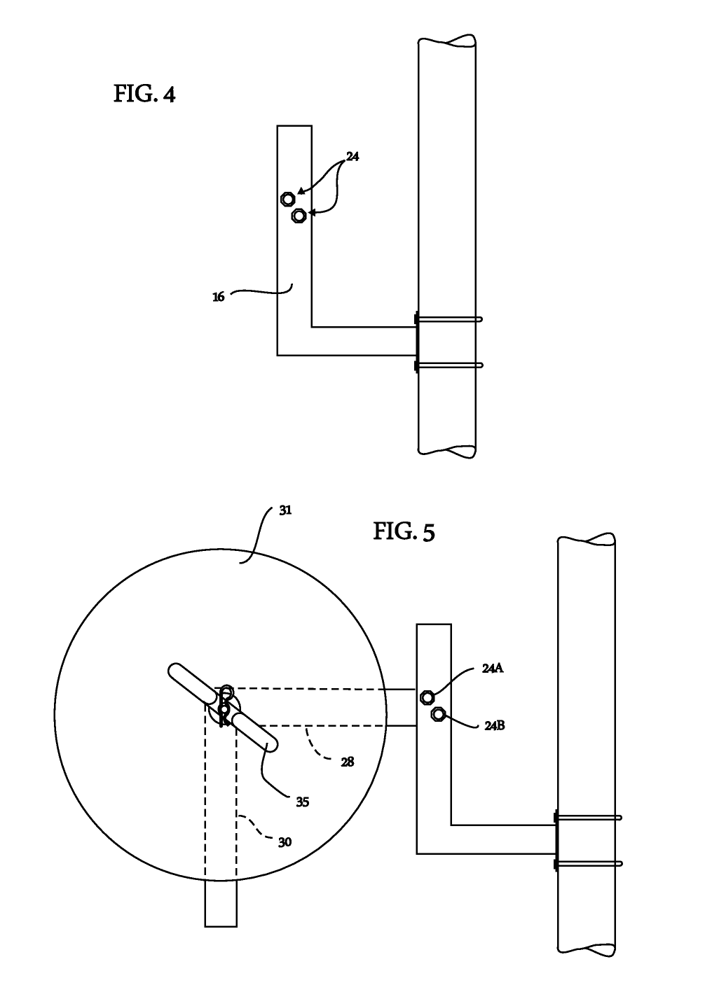

The side beam portion 16 of the first rack member 12, in preferred embodiments of the invention, is provided with installment holes 24; as shown by example in FIGS. 4 and 5, and other illustrations.

The Rack System 10 is additionally provided with a removable, or releasable, spool support bracket member 26. The spool support 26 is provided with its connection shaft, or portion, 28; and its support shaft, or portion, 30. The connection shaft 28 has first and second ends 28A and 28B; and the support shaft 30 has first and second ends 30A and 30B. The first end 28A of the shaft 28 has, and defines, attachment holes 29 for register and connection, or attachment, with the installment holes 24 of the side beam 16 of the first rack member 12.

The spool support 26 is further provided with an axle member 32, illustrated, by example, in FIGS. 6A, 6B and 6C, and other illustrations; having a base diameter 33A, a central axle diameter 33B and a threaded portion 33C. The axle member 32 can also be provided in a uniform diameter; or in other shapes or configurations for the purpose of mounting appropriately in relation to a spool 31, with which it interacts, for movement thereof.

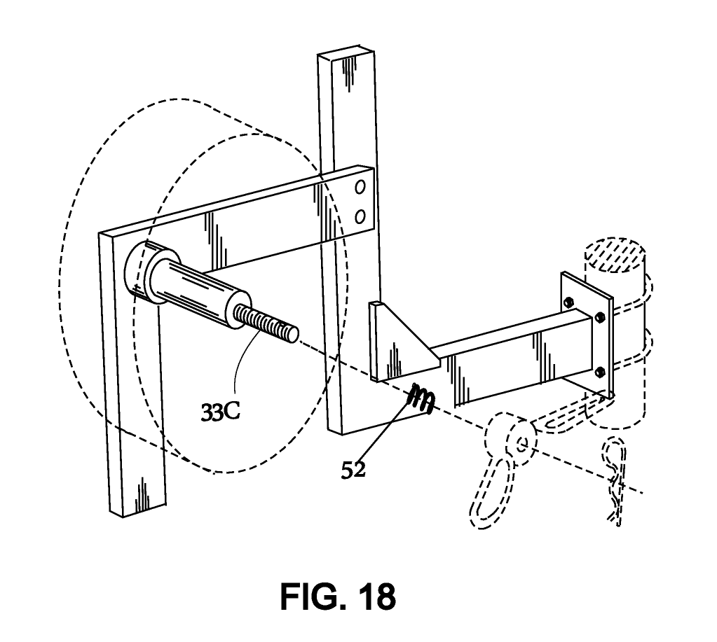

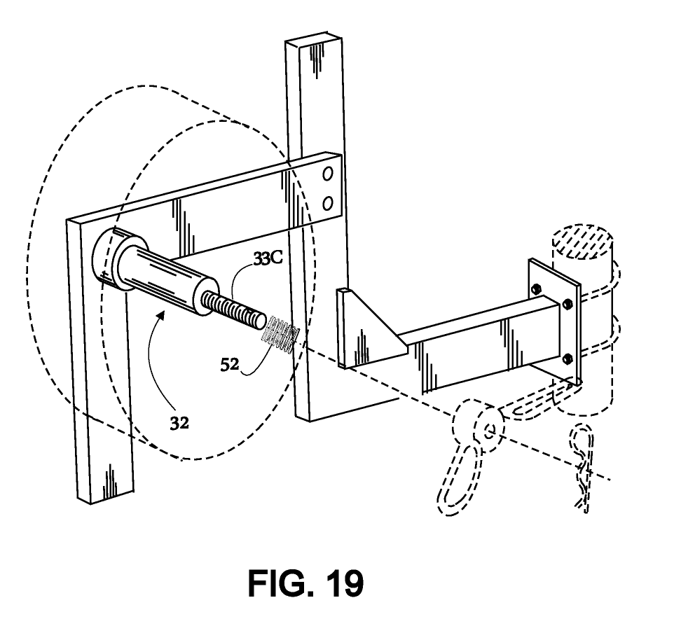

In preferred embodiments of the present invention, shown by example only in FIGS. 18 AND 19, the biasing member 52 is installed ahead of, or as a part of, the axle securing member, wingnut or other securing means 35, so that when the spool member 31 is installed the member 52 provides biasing or spring-like pressure against the spool 31. In a preferred embodiment the biasing member 52 fits over and is mounted upon the threaded portion 33C of the axle member 32. It will be understood within the full scope and spirit of the invention that a number of diverse types of biasing members or mechanisms can be utilized to help secure, position and/or guide the spool 31 or other types of such dispensers discussed herein which are mounted on or in relation to the axle member 32. For example, biasing means could include in addition to standard spring-like and pressure-providing device members such systems or members as those relating to pneumatic, hydrostatic and/or hydraulic methods or resources. A number of other means can be employed to provide the pressure desired in this aspect of the invention.

The spool support 26 is attached or connected, in parts or integrally, to a general area or portion where the connection shaft 28 and the support shaft 30 come together; as illustrated by example in FIGS. 2, 3, 5, 6A, 6B, 6C, 6E, 11, 13 and 14. As configured, designed, attached or installed; the axle 32 is positioned to represent a z-axis in relation or reference to the attached connection and support shafts 28 and 30 which positionally, generally or substantially, represent an x-axis and a y-axis along positionally imaginary Cartesian Coordinates. Other angles and positioning can be utilized to best take advantage of the layout, positional arrangement or topography of the rear portion of a forklift vehicle 11.

Further, in preferred embodiments, the axle member 32 functions in interaction with a number of different types of spool members 31; shown by example in the illustrations; which are axially and rotateably installed on the axle member 32 for use, in interaction therewith, in providing easily accessible tying or wrapping materials in positional relation to the rear portion of the forklift vehicle 11; and in convenient positional relation to the first and second rack members, themselves, 12 and 36, of the present invention.

Also, in preferred embodiments, the installed spool member 31 is secured on the axle 32 by the washer member 34 and the axle securing member 35, which can be a wingnut and clip or other type of appropriate securing means or member among many such securing means available. This is illustrated, by example, in FIGS. 2, 3, 5 6A and 6E.

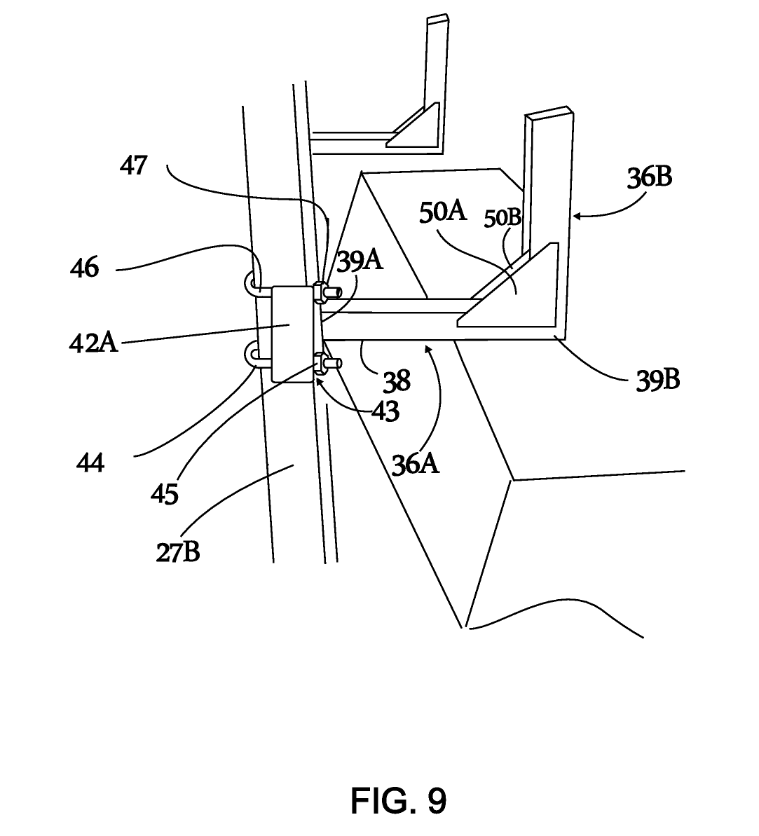

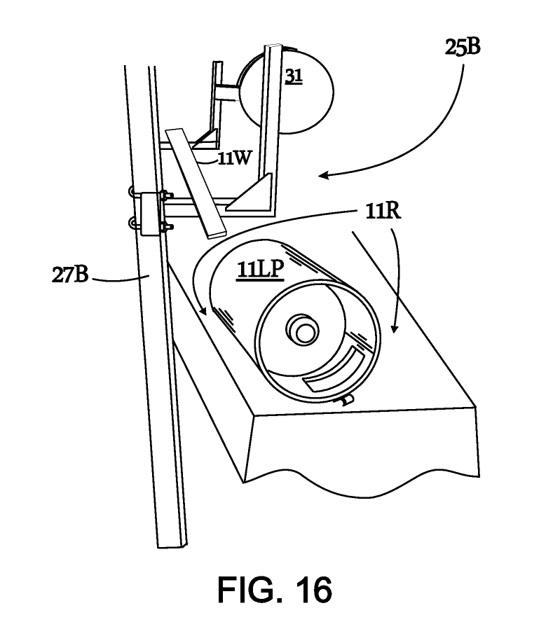

The Rack System 10 is further provided with a second rack member, having the surface beam portion 38 with its first and second ends 39A and 39B; and the side beam portion 40, having its first and second ends 41A and 41B. The first end 41A of the side beam 40 is attached, integrally or in parts, to the second end 39b of the surface beam 38. The first end 39A of the surface beam 38 is provided with the base plate 42, as illustrated by example in FIG. 9 (see better view of holes 19 on the first rack member 12 in FIG. 6C). The base plate 42 defines and has bolting holes 43, for accepting a first U-bolt (or square bolt, etc.) 44 and a second U-Bolt (or square bolt) 46; for securement with first and second U-Bolt Nuts 45 and 47. In this regard, one can select a first position 25A, among other preselected installation positions, as shown by example in FIGS. 1 and 6D; and a second position 25B as shown by example in FIGS. 16, 17 and 22, preselected among a number of other installation positions in relation to support columns of the overhead guard 25 (or other such positions available, or adaptable on other types of fork lift units (for example, a diesel fork lift unit). The second position 25B selection can permit easy retrofit or adaption of the present invention to installation in such fork lift vehicles such as the Yale vehicle models, or other such units; where little or no space exists between the positional placement of a propane tank or other fuel source 11LP and the position of portions of the overhead guard 25 of a forklift 11; or available areas on other propane or similarly fueled forklifts or diesel or electric fork lift vehicles. Attachment and installation in other respects, herein, is similar to that as earlier described regarding the base plate 18 to position 25A of the overhead guard 25 of a forklift vehicle 11, or on a spatially available vertically oriented support member.

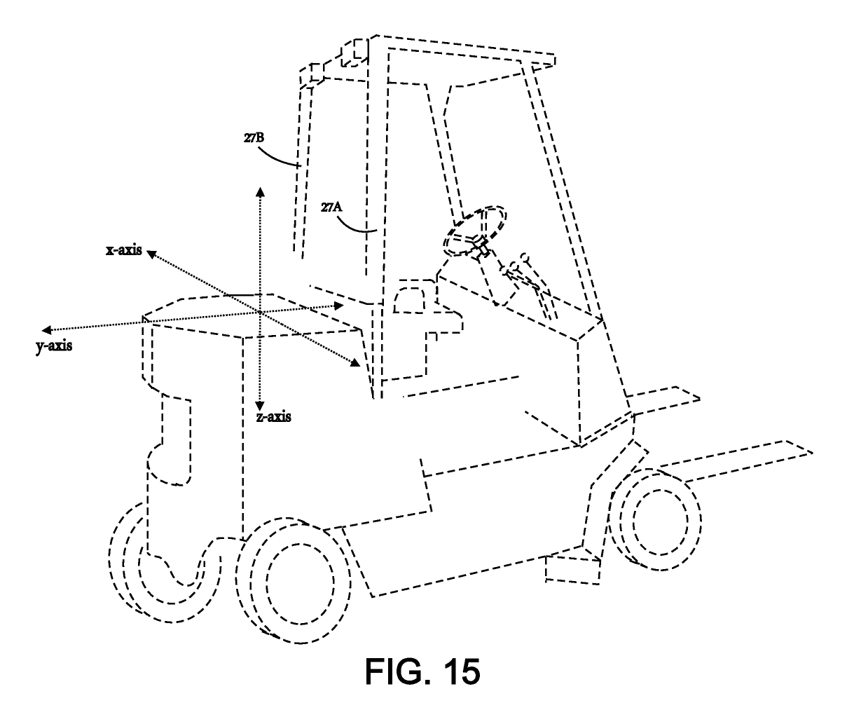

In preferred embodiments, the installed positional orientation of the first and second rack members 12 and 36, in relation to one another, is, essentially, parallel and on opposite sides of the rearward portions 11R and overhead guard 25 of a selected forklift vehicle 11; as illustrated, by example only, in FIGS. 2, 3, 7, 9, and 16. As described and disclosed in more detail herein, each of the first and second rack members 12 and 36 are preferably positioned along an x-axis illustrated by example in FIG. 15, and parallel to one another along a y-axis.

In additional preferred embodiments, a wood and elongate member transport rack system and tie spool mounting means device 10 is provided for use in achieving a positional advantage in mounting and carrying elongate objects, in positional interaction with a fork lift-type vehicle 11 having a wheeled or tracked-chassis base 11A for movement in relation to the ground and supporting fore and aft sections above the ground, a driver area 11B in the fore section, and a protective roof or other member covering 25 the driver area 11B supported by at least first and second support columns, 27A and 27B respectively, generally vertical in positional orientation in relation to a generally flat ground area 11G or at an angle slightly off-vertical in placement. As shown by example in FIG. 15, the aft section inherently defines imaginary positional coordinates where the width thereof is defined generally along the x-axis, the length thereof generally defined along the y-axis and the vertical magnitude thereof, above and below itself in relation to the ground area 11G which it occupies, defined generally along the z-axis. The vertical positioning of the first and second support columns 27A and 27B of the protective roof are generally parallel with the z-axis. The aft section or rearward portions 11R conventionally has and supports a fuel tank 11 LP, or vertically raised or protruding structure, generally positioned along the x-axis in spaced relation to the first and second vertically oriented support columns 27A and 27B.

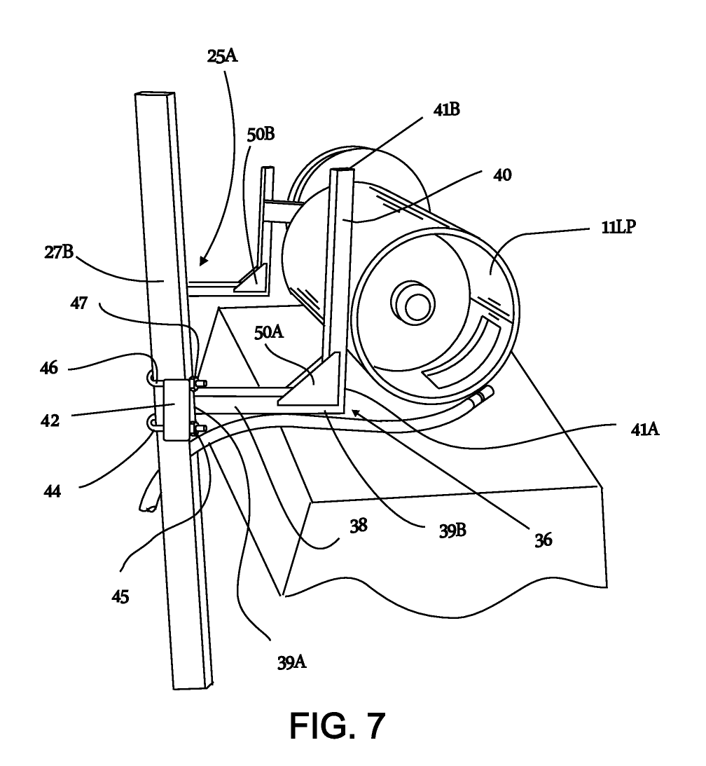

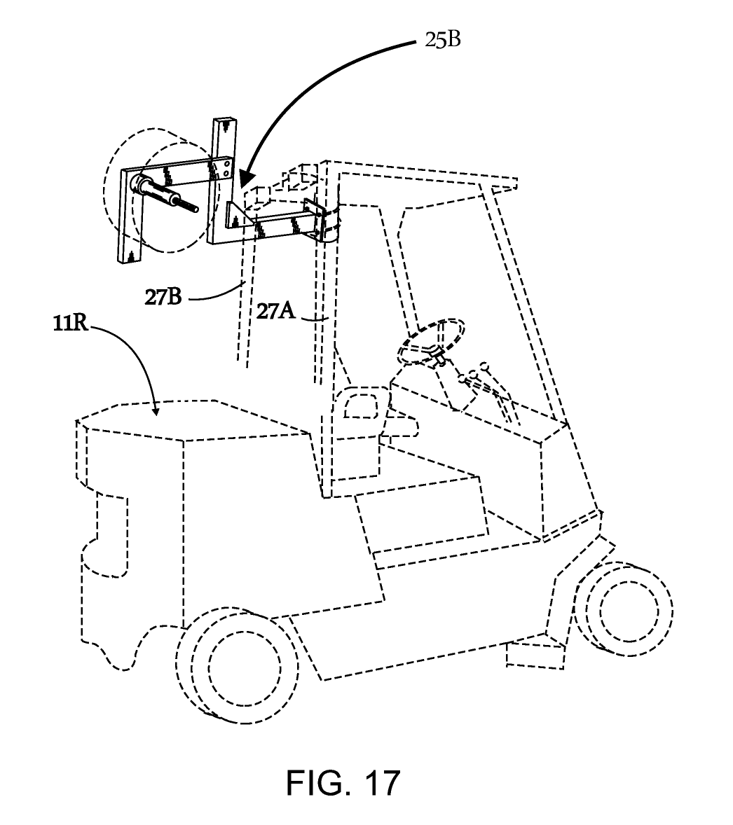

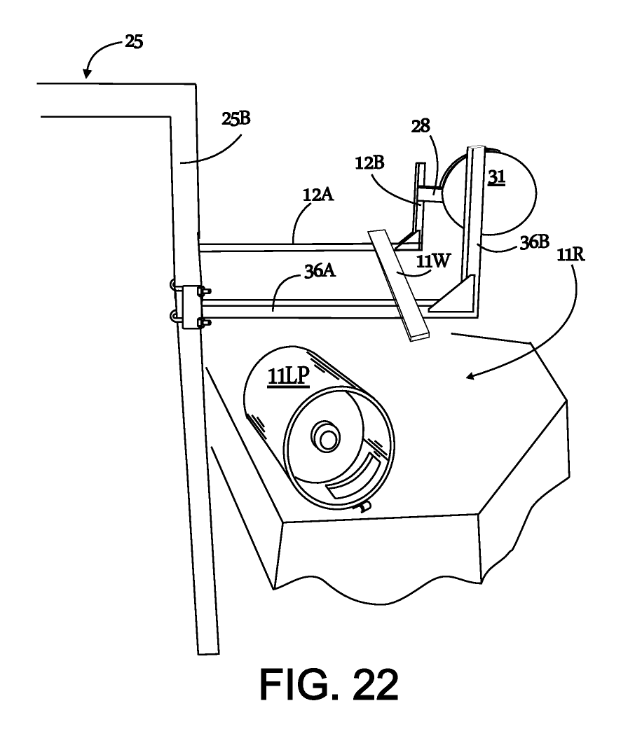

In related preferred embodiments the device of the present invention comprises a first support rack member 12 having first and second sections, 12A and 12B respectively, attached to one another, as shown by example in FIGS. 6E, 10 and 12. The first section 12A has means for vertically positioning or attaching the free end thereof to a vertical portion of the first support column 27A. The first section 12A, as installed and positioned, extends generally parallel to the y-axis of the aft section. The second section 12B is attached to the first section 12A at a generally transverse angle, extending above the first section 12A and the aft section 11R generally parallel to the z-axis, as shown by example in FIG. 6D and other illustrations. The device also has a second support rack member 36 having first and second sections 36A and 36B respectively, attached to one another, as shown by example in FIGS. 9 and 16. The first section 36A has means for vertically attaching the free end thereof to a vertical portion of the second support column 27B so that, as installably positioned, the first section extends generally parallel to the y-axis of the aft section (see axis configuration shown by example in FIG. 15). These means in a preferred embodiment include, as already discussed in part herein, U-bolt members 44 and 46, U-bolt nuts 45 and 47 and the base plate 42. The plate 42 is provided with holes 43 to receive and be secured to the vertical position on the support column 27B chosen to mount the second support rack member 36. The plate can also be flanged in construction or configuration so that part of the base plate wraps around a portion of the support column while also wrapping around, encircling, positioning or tracking part of each respective U-bolt member, as shown by example in FIG. 7-9. Other similar types of attachment means or systems can be used where the base plate 42 is attached to a selected vertical position on the second support column 27B by bolts, clamping, coupling or vice members and other members for securing the base plate 42 and the attached first section 36A and rack member 36 to the support column 27B so that this attachment system can be loosed or removed and placed at another vertical position on the support column 27B. Two such different vertical positions in this regard are shown at 25A in FIGS. 1, 6D and 7 and 25B in FIGS. 16 and 17. Other positions are possible by loosing or removing the U-bolts in this case, or similar attachment members or means and re-positioning the respective rack member. Additionally, longer respective first sections 12A and 36A of the first and second support racks 12 and 36, positioned as indicated along respect parallel y-axes, can allow the transport and positioning of elongate members 11W to extend out, over and beyond positioning of propane and fuel tank members 11W and/or other protruding or vertically dimensioned objects or members, taking advantage of space representing rearward and aft areas 11R of the forklift-type vehicle 11; as shown by example in FIG. 22.

The second section 36B is attached to the first section 36A at a generally transverse angle, as shown by example, extending above the first section 36A and the aft section 11R, generally parallel to the z-axis. The first section 36A of the second support rack member 36 is positioned generally along the x-axis spaced and separate from the first section of the first support rack member, and generally parallel to the y-axis, so that elongate objects or members 11W shown by example in FIGS. 1, 16 and 22, generally positioned along the x-axis and intersecting therewith, can be supported by the first and second support rack members 12 and 36 when in installed position, between the fuel tank of the aft section and the first and second columns; and so that such elongate objects, when so dimensioned, when positioned onto the first and second support rack members 12 and 36, can extend beyond the width of the aft section and the perimeters of the first and second support columns 27A and 27B.

In this related regard, the device further comprises the subassembly of parts discussed at other locations herein related to attachment and operation of the tie spool or spool member 31, shown by example in this instance in FIG. 6E. This embodiment is shown having the connection portion 28, its first end 28A, and its second or supportable end 28B. The first end 28A is securely attached to the second section 12B of the first support member 12 so that the supportable end 28B extends generally parallel to the y-axis positioning discussed herein in relation to the aft section or rearward portion 11R shown by example in FIG. 15. The supportable end 28B has the securable elongate axle or axle member 32 extending generally parallel to the x-axis, and the support shaft or portion 30 is attached at a generally transverse angle to the supportable end 28B so that it extends to a position generally flush with the aft section 11R and is basically parallel to the z-axis.

Also, in this regard the device further has the tie material spool dispenser or spool member 31. The dispenser 31 is rotateably and pivotably mounted on the elongate axle member 32, and what can be regarded in terms of the invention as exchangeable means for securing the tie material spool dispenser 31 is also mounted on the axle member 32 as well. Such exchangeable means or sub-assembly for securing the spool member 31 is shown by example in FIG. 6E in having the securing member or hand-turnable wingnut and clip at 35, and is shown by example in FIG. 6A having a washer element or member 34. It will, however, be understood in this regard within the scope and spirit of the invention that such exchangeable means can be any of a number of fixable, installable and releasable members to provide further installed stability or security to the spool member 31 once installed on the axle 32.

The means or ability for vertically attaching the second section 12B, or what becomes the free end in this embodiment, of the first rack member 12 constitutes, in a preferred embodiment, the base plate 18, shown by example in FIGS. 6B, 6C and 6E as well as other drawings. The base 18 has or defines holes 19, and is provided with at least one or more securing U-bolt member(s) 20 and/or 22 for engagement and registering with the holes 19 for securing the base plate 18 to a portion of the first support column 27A. In like manner, the means or ability for vertically attaching the second section 36B, or what becomes the free end in this embodiment, of the second rack member 36 includes the base plate 42, or flanged base plate 42A ash shown by example in FIG. 9, which is provided with holes 43, and one OR MORE securing U-bolt member(s) 44 and/or 46 for engagement and registering with the holes 43 for securing the base plate 42 to a portion of the second support column 27B.

The earlier referenced subassembly of parts discussed at other locations herein related to attachment and operation of the tie spool or spool member 31 is further characterized within the scope of the invention, as discussed and illustrated herein, by the support shaft portion 30 being attached to a portion of the supportable end 28B of the connection portion 28, and at least a portion thereof extends generally along the z-axis to make contact with and provide support from the aft section 11R of the vehicle with which it is used in interaction or in combination; as shown by example at FIGS. 1 and 6D.

Additionally, the scope and spirit of the present invention include a number of types of shapes and dimensioning with regard to the structural elements of the invention discussed. One example only of such dimensioning is shown in FIG. 6F. In part this has previously been discussed with regard to integral or attached member pieces regarding the first rack member 12, the spool support bracket member 26 and the second rack member 36.

Other aspects, along these lines, exist, and are part of and included within the scope and spirit of the present invention.

For example, the U-Bolts 20, 22, 44 and 46 are preferably one-quarter inch (0.25″ or ¼″) in size with corresponding nuts 21, 23, 45 and 47. Also, as discussed above the bolts 20, 22, 44 and 46 can be square, rectangular or otherwise arced, or

curvilinear in shape and configuration. Additionally, many other diverse means, methods or systems of attachment can be utilized to detachably or integrally secure each of the first and second rack members, 12 and 36, respectively, to installment portion, portions, area or areas, or positioning in relation to, or combination with, a forklift vehicle, and/or in relation to an overhead guard structure 25 (or similar such structure); on or in relation to a forklift vehicle 11. In this regard, it will be appreciated by those skilled in the art, or in this technology, that though such attachment or installment means could include means requiring the drilling of holes or other areas within or a part of an overhead guard structure 25; Federal and/or state provisions, regulations and/or statutes require that structures of whatever nature be attached to an overhead guard area by means other than drilling a hole, or in like manner violating the structural integrity of an overhead guard member, structure or area on a forklift. Therefore, the present invention envisions within the scope thereof many diverse means of attachment, connection, combination and/or installment of its rack members 12 and 36; or the installment of respective (or single) rack members; or, by virtue of respective such installments of a plurality thereof (i.e., 2 or more such rack members); or by installment of respective or multiple spool support bracket member(s) 26.

The following manufacturers, among others, make forklift vehicles (diesel, gasoline and/or LP or Liquid Propane-fueled, as well as electrically powered vehicles), with which the present invention can interact through connection, attachment or retrofitted installation, or in manufactured combination with; include: HYSTER™, CLARK™, YALE™, NISSAN™, KOMATSU™, KALMER A/CDAEWOO™, CATERPILLAR™, MASTERCRAFT™, TOYOTA™, and MITSUBISHI™ (with “™” designating the status of these word marks as ‘Trademarks’ owned by each respective company). In this regard various surfaces, portions or areas are available with regard to these vehicles for installation of the present invention. The most frequent examples of such installations will constitute attachment, interaction or combination of members of the present invention with support columns of an overhead guard (25) member or similar element on such vehicles and/or in such attachment in positional relation to rear or aft surface areas of a forklift vehicle (11). Examples only are illustrated as shown in FIGS. 1, 6D, 7, 9, 16 and 17.

In one embodiment of the present invention, the spool support bracket member 26 is attached or connected to an inside rear wall of portion of a cabin (or driver's area) of a forklift (11), for mounting of a spool member 31 and/or tying material (or similar or other coiled securing material) in readily accessible positional relation to such cabin or driver's area of a forklift vehicle (11).

Further, the types of bolts or connections 24A and 24B used to connect the spool support bracket member 26 to the first rack member 12, in reference to the installment holes 24 and the attachment holes 29, when this connection is not integral; include 2 5/16 inch bolts having standard or course threading. However, ¼ to ½ inch bolts, as well as other sizes, can be utilized. Such bolts and corresponding nuts are utilized to register with and connect attachment holes 29 and installment holes 24; so that, in preferred embodiments, the connection shaft 28 of the spool support 26 can be securely, but detachably, connected/attached to the side beam 16 of the first rack member 12, as shown, by example, in FIGS. 1-3, 5; 6B, D-E; 10-14, and 17-21.

The present invention is so designed, and also includes within the scope and spirit thereof, the ability to conveniently disconnect the spool support 26; so that the present Rack System 10 can be utilized with just its first and second rack members 12 and 36, where work requirements make this more convenient, necessary or desired. This embodiment of the present invention is illustrated in part, by example, in FIG. 9. It will be understood that the height of the rack members 12 and 36, when so desired, can be selectively varied; as illustrated by example, in FIGS. 1, 6D, 7, 9, 16, 17 and 22; and that the functional and structural aspects in this regard are encompassed in the scope and spirit of the present invention.

Additionally, the threaded portion 33C of the axle member 32 can be, for example, a ½ inch standard bolt with course thread or a number of metric sizes with fine threading. Also, a ¼ inch to ⅞ inch bolt can be utilized as well as a number of other sizes; metric or standard; fine or course thread. Examples of the axle 32 are illustrated in FIGS. 2, 6A-E, 11, 13, 14 and 18-19.

Further, the washer member 34 is preferably about two (2) inches in overall, or largest, diameter; and has and defines an axial center hole having a diameter of about one (1) inch; so that it can be utilized between the axle securing member 35 (such a wingnut, clip or like, or other, securing means) to more securely and uniformly retain a spool member which can be mounted on the axle member 32. This is illustrated, by example only, in FIGS. 3 and 6A.

Additionally, exemplar dimensions for the spool support member 26 are set forth in FIG. 6F, as an example, only, of how this member can be dimensioned in its manufacture or fabrication. Many other sizes and dimensions can be utilized within the scope and spirit of the present invention.

The angle between the surface beam 14 and the side beam portion 16, of the first rack member 12; as well as the that between the surface beam 38 and side beam portion 40 of the second rack member 36; can be from about 70 degrees to about 110 degrees, though illustrative, exemplar illustrations in the drawing figures, herein, show the angles to be about, or generally at, 90 degrees; and this is for many purposes the preferred angulation thereof. It is also within the scope and spirit of the present invention to set the angle between the connection shaft 28 and the support shaft 30 of the spool support member 26 at an angle of about 80 degrees to about 110 degrees, or within a small to medium range beyond a 90 degree angle; and this is illustrated by example in such drawings as FIGS. 1, 6A, 6B, 6D, 6E; with a generally 90 degree angulation being illustrated by example, in preferred embodiments of the present invention, in FIGS. 2, 3, 5, 6F and 7. The angulation, in preferred embodiments of the invention with regard to the angle between the axle member 32 and the support shaft 30 is at a generally transverse angle in positional relation thereto, but along another axis in relation to the support shaft 30 and the connection shaft 28 of the spool support member 26, as illustrated in the examples set forth in the drawing and photographic figures herein. Other angles within this range can be utilized in response to mounting different sizes of spools with which the present invention interacts, or is used in connection or combination with in preferred embodiments of the present invention.

Further, as discussed in part above herein; the Rack System 10 can be positioned and secured at different levels or heights in relation to the attachment of the rack members 12 and 36 to the overhead guard 25.

It will be noted that channeled metal, steel or metal alloy can be utilized in the fabrication and structure of the rack members 12 and 36, and the spool support 26; using in parts the channeled, grooved or square or U-like portions of such steel or metal, etc., for the various connections described herein. Also, flat, more linear-shaped, surfaces for construction and connection of the elements of the present invention can be utilized. It will, therefore, be understood that the spirit and scope of the present invention will include the use of various shapes and types of materials, and surface configurations, to construct or fabricate the elements discussed herein of the Rack System 10; with regard to the rack members 12 and 36, the spool support member 26, and the associated parts, elements and holes discussed herein with regard thereto.

It is also with the scope and spirit of the present invention to utilize a wide range of metals, metal alloys, steel, graphite, polymers, glass or polymer alloys, or composites of various substances or materials in the structure, fabrication or manufacture of the elements, and associated parts or portions, of the present invention.

Additionally, in preferred embodiments, the rack members 12 and 36, and the spool support 26, are provided with backup support members 50A and 50B; as shown, by example, in FIGS. 1-3, 6B, 6E, 7, 9, and 16-21.

Intellectual property rights under the Patent Law are set forth and encompassed in the following claims. These claims should not be limited by the examples set forth in the drawings and specification, but should be determined by the full scope and breath of the ideas and concepts of the presented claims and their legal equivalent.

Accordingly, I claim:

1. A device comprising a wood and elongate member transport rack system and tie spool mounting means, for use in achieving a positional advantage in mounting, tying and transporting wood and elongate objects in relation to an aft spaced width portion of a forklift-type vehicle with which the device interacts, the fork lift-type vehicle having a wheeled or tracked-chassis base for movement in relation to a ground area and supporting fore and aft sections above a ground area, a driver area in the fore section, and a protective roof covering the driver area supported by at least first and second generally vertically oriented support columns in relation to a ground area although each of the columns may be at an angle in relation to a ground portion, the aft section defining imaginary positional coordinates where the width thereof is defined generally along the x-axis, the length thereof generally defined along the y-axis and the vertical magnitude thereof above and below a ground portion defined generally along the z-axis; the aft section having and supporting a fuel tank generally positioned along the x-axis in spaced relation to the first and second vertically oriented support columns; wherein:
the transport rack system comprising at least first and second separately positioned and unconnected support rack members:
the first support rack member having first and second sections attached to one another, the first section having means for vertically attaching the free end thereof to a generally vertical portion of the first support column such that when installably attached the first support member is securely positioned and non-pivotable, and such that at least a part of the first section extending generally parallel to the y-axis of the aft section, and the second section thereby having at least a part thereof extending generally parallel to the z-axis above the first section and aft section when installably and securely positioned, the first and second sections when affixed to one another and placed in installed position being able to retainably receive elongate objects generally positioned along the x-axis and intersecting positionally with axis portions of the first and second sections, when cooperating with the second support rack member, and
the second support rack member having first and second sections attached to one another, the first section having means for vertically attaching the free end thereof to a generally vertical portion of the second support column such that when installably attached the first support member is securely positioned and non-pivotable, and such that at least a part of the first section extending generally parallel to the y-axis of the aft section, and the second section thereby having at least a part thereof extending generally parallel to the z-axis above the first section and aft section as installably and securely positioned, the first and second sections when affixed to one another and placed in installed position being able to retainably receive elongate objects generally positioned along the x-axis and intersecting positionally with axis portions of the first and second sections;
said second support rack member being positioned generally along the x-axis spaced and separate from, and generally parallel to the axis of the at least a part of the first section of the first support rack member extending generally parallel to the y-axis, so that such elongate objects generally positioned along the x-axis and intersecting therewith can be supported by said first and second support rack members, when in installed position, in said aft spaced width portion defined between the fuel tank of the aft section and the first and second columns, and so that such elongate objects when so dimensioned, when positioned onto said first and second support rack members, can extend beyond the x-axis dimensions of the aft section and the perimeters of the first and second support columns; and
the tie spool mounting means having at least first and supportable ends, the first end being fixedly attached to the first support member such that at least a portion of the supportable end extending concurrently with the axis of the at least a part of the first section of the first support member extending generally parallel to the y-axis, said supportable end having a securable elongate axle member extending generally parallel to the x-axis, for rotatable and pivotable receipt of rotating members.

2. The device of claim 1 wherein said means for vertically attaching the free end of the first section of the first support rack member to a generally vertical portion of the first support column comprises a base plate defining at least two holes, and at least one securing U-bolt member for engagement and registering with said at least two holes for securing the base plate to the vertical portion of the first support column, and
said means for vertically attaching the free end of the first section of the second support rack member to a generally vertical portion of the second support column comprises a base plate defining at least two holes, and at least one securing U-bolt member for engagement and registering with said at least two holes for securing the base plate to the vertical portion of the second support column.

3. The device of claim 1 wherein the tie spool mounting means further having a support member attached to a portion of the supportable end of the tie spool mounting means, wherein at least a portion thereof extends generally along the z-axis to make contact with and provide support from the aft section, thereby providing support to said tie spool mounting means and the first support member.

4. The device of claim 1 wherein the securable elongate axle member further comprising first and second ends, the first end defining a base diameter, and, outboard of or distally proximate thereto, a central axle diameter for receiving rotating members, the second end having and defining a threaded axial portion adjacent to said central axle diameter.

5. The device of claim 4 wherein the securable elongate axle member further comprising securement means for securably mounting rotating members onto the central axle diameter.

6. The device of claim 5, wherein said securement means comprising a securable hand-turnable nut, said nut being threadably received on the threaded axial portion to pivotally mount a rotating member onto the central axle diameter.

7. The device of claim 4 wherein the securable elongate axle member further comprising biasable securement means for securably mounting rotating members onto the central axle diameter.

8. The device of claim 7 wherein the biasable securement means comprising a securable hand-turnable nut and a spring member, said spring member being mounted on the threaded axial portion, and said nut thereafter being threadably received on the threaded axial portion, for biasably and pivotally mounting a rotating member onto the central axle diameter.

9. The device of claim 5, wherein the spool mounting means further comprises a dispensable spool having and being able to dispense severable tying material, said spool being pivotably and rotateably mounted on the central axle diameter.

10. A wood and elongate member transport rack system and tie spool mounting means device, for use in achieving a positional advantage in mounting and carrying elongate objects, in positional interaction with a fork lift-type vehicle having a wheeled or tracked-chassis base for movement in relation to the ground and supporting fore and aft sections above the ground, a driver area in the fore section, and a protective roof covering the driver area supported by at least first and second support columns being generally vertical in positional orientation in relation to a generally flat ground area or being at an angle slightly off-vertical in placement, the aft section defining imaginary positional coordinates where the width thereof is defined generally along the x-axis, the length thereof generally defined along the y-axis and the vertical magnitude thereof above and below the aft sections of the vehicle in relation to the ground defined generally along the z-axis, the vertical positioning of the first and second support columns of the protective roof being generally parallel with the z-axis; the aft section having and supporting a fuel tank or other structure generally positioned along the x-axis in spaced relation to the first and second vertically oriented support columns, the device comprising:
a first support rack member having first and second sections attached to one another, the first section having means for vertically attaching the free end thereof to a vertical portion of the first support column such that, as installably positioned, the first section extends generally parallel to the y-axis of the aft section, the second section being attached to the first section at a generally transverse angle, extending above the first section and the aft section generally parallel to the z-axis, and
a second support rack member having first and second sections attached to one another, the first section having means for vertically attaching the free end thereof to a vertical portion of the second support column such that, as installably positioned, the first section extends generally parallel to the y-axis of the aft section, the second section being attached to the first section at a generally transverse angle, extending above the first section and the aft section generally parallel to the z-axis,
the first section of said second support rack member being positioned generally along the x-axis spaced and separate from the first section of the first support rack member, and generally parallel to the y-axis, so that elongate objects generally positioned along the x-axis and intersecting therewith can be supported by said first and second support rack members, when in installed position, between the fuel tank of the aft section and the first and second columns, and so that such elongate objects, when so dimensioned, when positioned or placed onto said first and second support rack members, can extend beyond the width of the aft section and the perimeters of the first and second support columns; and
a tie spool mounting subassembly having at least first and supportable ends, the first end being fixedly attached to the second section of the first support member such that the supportable end extends generally parallel to the y-axis,
the supportable end having a securable elongate axle member extending generally parallel to the x-axis, a support member being attached at a generally transverse angle to the supportable end such that it extends to a position generally flush with the aft section generally parallel to the z-axis,
a tie material spool dispenser, the dispenser being rotateably and pivotably mounted on the elongate axle member, and exchangeable means for securing the tie material spool dispenser as mounted on the elongate axle member.

11. The device of claim 10 wherein said means for vertically attaching the free end of the first support member comprises a base plate defining at least two holes, and at least one securing U-bolt member for engagement and registering with said at least two holes for securing the base plate to said portion of the first support column, and
said means for vertically attaching the free end of the second support member comprises a base plate defining at least two holes, and at least one securing U-bolt member for engagement and registering with said at least two holes for securing the base plate to said portion of the second support column.

12. The device of claim 10 wherein the tie spool mounting subassembly further having a support member attached to a portion of the supportable end of the tie spool mounting means, wherein at least a portion thereof extends generally along the z-axis to make contact with and provide support from the aft section.

13. A device for transporting wood and elongate objects across the width of a forklift-type vehicle, for use in achieving a positional advantage in mounting and carrying elongate objects in relation thereto, the forklift-type vehicle having a wheeled or tracked-chassis base for movement in relation to the ground and supporting fore and aft sections above the ground, a driver area in the fore section, and a protective roof covering the driver area supported by at least first and second support columns being generally vertical in positional orientation in relation to a generally flat ground area or being at an angle slightly off-vertical in placement, the fore section having conventional means for hoisting and transporting heavy objects by steel fingers inserted under the load, the aft section defining imaginary positional coordinates where the width thereof is defined generally along the x-axis, the length thereof generally defined along the y-axis and the vertical magnitude thereof above and below the ground defined generally along the z-axis, the vertical positioning of the first and second support columns of the protective roof being generally parallel with the z-axis; the aft section having and supporting a fuel tank generally positioned along the x-axis, the device comprising:
a first rack member having first and second sections; the first section being generally rectangular in shape having at least one surface portion, at least one side portion, and first and second ends, the first end of the first section having means for vertically positioning and securing the first section of the first rack member at a vertical position on the first support column; the second section having first and second ends, a connecting side and at least two surface sides, and being attached at its first end to the second end of the first section at a generally transverse angle such that the first and second sections, when attached, have an L-configuration when viewed from the side or side perspective thereof, the second section as attached and positioned extending above the first section and the aft section generally parallel to the z-axis;
a second rack member having first and second sections; the first section being generally rectangular in shape having at least one surface portion, at least one side portion, and first and second ends, the first end of the first section having means for vertically positioning and securing the first section of the second rack member at a vertical position on the second support column; the second section having first and second ends, a connecting side and at least two surface sides, and being attached at its first end to the second end of the first section at a generally transverse angle such that the first and second sections, when attached, have an L-configuration when viewed from the side or side perspective thereof, the second section as attached and positioned extending above the first section and the aft section generally parallel to the z-axis;
the first and second rack members as so positioned and secured, respectively, in relation to the first and second support columns, being separate and spaced from each other along the x-axis, and generally parallel to one another along the y-axis, such that they provide a support spaced between said first and second support columns and the fuel tank for placement of wood or elongate objects placed thereon generally parallel to the x-axis;
a tie spool mounting subassembly having at least first and supportable ends, the first end being fixedly attached to the second section of the first support member such that the supportable end extends generally parallel to the y-axis, a securable elongate axle member being attached to the supportable end and extending generally parallel to the x-axis, a support member being attached at a generally transverse angle to the supportable end such that it extends to a position generally flush with the aft section and generally parallel to the z-axis and when so attached having an inverted L-configuration when viewed from side or side perspective, and a dispensable spool having and being able to dispense severable tying material, said spool being pivotably and rotateably mounted on the securable elongate axle member.

14. The device of claim 13, wherein the securable elongate axle member further comprising first and second ends, the first end defining a base diameter, and, outboard of or distally proximate thereto, a central axle diameter, the second end having and defining a threaded axial portion adjacent to said central axle diameter; said dispensable spool being said pivotably and rotateably mounted on the central axle diameter.

15. The device of claim 14, further comprising a securement subassembly having a hand-turnable wide-based nut, said nut being threadably received and installed on the threaded axial portion.

16. The device of claim 15, wherein the securement subassembly further comprises a clip member, the threaded axial portion defining a hole through its diameter, the clip member being received through the hole after the wide-based nut has been installed.

17. The device of claim 15, wherein the securement subassembly further comprises a positionable biasing member, being slideably mounted and installed over the threaded axial portion, prior to installing the hand-turnable wide-based nut.

18. The device of claim 13, wherein the means for vertically positioning the first rack member at a vertical position on the first support column comprises a base plate fixedly secured to the first end of the first section, the base plate defining and having at least first and second holes; at least one U-bolt member, the U-bolt member being secured around a vertical position of the first support column and secured to the base plate such that the first rack member is supported generally parallel to the y-axis between said first support column and the fuel tank of said forklift-type vehicle; and
the means for vertically positioning the second rack member at a vertical position on the second support column comprises a base plate fixedly secured to the first end of the first section, the base plate defining and having at least first and second holes; at least one U-bolt member, the U-bolt member being secured around a vertical position of the first support column and secured to the base plate such that the first rack member is supported generally parallel to the y-axis between said second support column and the fuel tank of said forklift-type vehicle; and
wherein each of the first and second rack members can be positioned, at least, at first and second vertical positions, respectively, on the first and second support columns, and by so doing, provide support for wood and elongate members between said support columns and the fuel tank and above the fuel tank.

19. The device of claim 18 wherein the base plate of said means for vertically positioning the first rack member and the base plate of said means for vertically positioning the second rack member, each, further comprise at least one flange member which extends from an edge of the base plate and encircles both the respective U-bolt and the respective support column at least in part when in installed position.
